(19) United States
(12) Patent Application Publication
(10) Pub. No.: US 2015/0090909 A1
(43) Pub. Date: Apr. 2, 2015

(54) SELECTABLE VIEW ANGLE OPTICAL SENSOR

(71) Applicant: Capella Microsystems (Taiwan), Inc., New Taipei City (TW)

(72) Inventors: Cheng-Chung SHIH, Fremont, CA (US); Koon-Wing TSANG, Fremont, CA (US); Yuh-Min LIN, San Ramon, CA (US)

(21) Appl. No.: 14/308,624

(22) Filed: Jun. 18, 2014

Related U.S. Application Data
(60) Provisional application No. 61/884,390, filed on Sep. 30, 2013.

(51) Int. Cl. G01J 1/06

(52) U.S. Cl. CPC G01J 1/06; G01J 2001/063
USPC 250/578.1

(57) ABSTRACT

A selectable view angle optical sensor is disclosed. The selectable view angle optical sensor comprises a substrate, a photodiode array disposed on the substrate, a first optical shielding modulation layer disposed on a first plane and a second optical shielding modulation layer disposed on a second plane. The first plane is on the photodiode array, the second plane is on the first plane, and the first and second planes and a top surface of the photodiode array are substantially in parallel. The dimensions and configurations of the first and second optical shielding modulation layers limit a field of view of the photodiode array so that the photodiode array has selectable view angle function.

### CROSS-REFERENCE TO RELATED APPLICATION

This application claims the benefit of US. Provisional Patent Application No. 61/844,390, filed on Sep. 30, 2013, in the United States Patent and Trademark Office, the disclosure of which is incorporated herein in its entirety by reference.

### BACKGROUND OF THE INVENTION

1. Field of the Invention

The exemplary embodiment(s) of the present invention relates to an optical sensor. More specifically, the exemplary embodiment(s) of the present invention relates to a selectable view angle (SVA) optical sensor.

2. Description of Related Art

In recent years, the optical sensing technology has major progress with the development of the manufacturing technology, and many power saving applications for better displays continuously pushing optical sensing technology to offer multiple features in a small form factor. Also, the optical proximity sensor (OPS) apparatus is one of the applications, which is commonly used in wireless communications, bio-molecular sciences, environmental monitoring, and displays. The UPS apparatus is developed based on the light signal received by the photodiode via the reflections of the measured object. The photodiode transfers the received light signal to an electrical signal. By detecting the intensity of the electrical signal, the UPS apparatus can obtain the gesture motion of the measured object.

To more precisely determine the direction of movement of the measured object, the UPS apparatus needs optical sensors having high directivity. That is, such optical sensors should only receive light from a predetermined area or angle. One of the methods to make the optical sensors have the selectable view angle function is to add extra lens or having multiple light emission diodes in the OPS apparatus. Thus, the production cost may increase and the reliability may decrease due to the extra structures. Besides, it is difficult for the OPS apparatus to be miniaturized or packaged so that it is difficult for the OPS apparatus to be applied in mobile devices.

Thus, for the demand, using a low-cost and simple method to manufacture an optical sensor with selectable view angle function has become a concern for the application in the market.

### SUMMARY OF THE INVENTION

A selectable view angle optical sensor is disclosed. The selectable view angle optical sensor comprises a substrate, a photodiode array disposed on the substrate, a first optical shielding modulation layer disposed on a first plane and a second optical shielding modulation layer disposed on a second plane. The first plane is on the photodiode array, the second plane is on the first plane, and the first and second planes and a top surface of the photodiode array are substantially in parallel. The dimensions and configurations of the first and second optical shielding modulation layers limit a field of view of the photodiode array so that the photodiode array has selectable view angle function. In addition, because of the layer structure of the first and second optical shielding modulation layers, the manufacturing process of the disclosed selectable view angle optical sensor can be fully compatible with complementary metal-oxide-semiconductor (CMOS) and BiCMOS process.

Preferably, the first optical shielding modulation layer may comprise a plurality of first optical shielding strips configured in parallel, the second shielding modulation layer may comprise a plurality of second optical shielding strips configured in parallel, and the plurality of first optical shielding strips and the plurality of second optical shielding strips may be substantially parallel to each other.

Preferably, the plurality of first optical shielding strips may be spaced apart from each other at a first distance, and the plurality of second optical shielding strips may be spaced apart from each other at a second distance.

Preferably, the photodiode array may have two different viewing angles of the field of view in a cross-section view.

Preferably, the photodiode array may further comprise a plurality of sub-photodiodes.

Preferably, the first or second optical shielding modulation layers may be made of metal.

Preferably, the first or second optical shielding modulation layers may be interference filters.

Preferably, the selectable view angle optical sensor may further comprise a dielectric layer disposed between the first and the second optical shielding modulation layers.

Another selectable view angle optical sensor is disclosed. The selectable view angle optical sensor comprises a substrate, a photodiode array disposed on the substrate, a first optical shielding modulation layer disposed on a first plane, a second optical shielding modulation layer disposed on a second plane and an optical filter layer disposed on the second optical shielding modulation layer to allow light with a predetermined wavelength passing through the selectable view angle optical sensor. The first plane is on the photodiode array, the second plane is on the first plane, and the first and second planes and a top surface of the photodiode array are substantially in parallel. The dimensions and configurations of the first and second optical shielding modulation layers limit a field of view of the photodiode array so that the photodiode array has selectable view angle function. In addition to the advantages provided by the former selectable view angle optical sensor, this selectable view angle optical sensor in fact can offer better selectivity on wavelength of a light source and the view angle for this selectable view angle optical sensor itself by applying the optical filter layer.

With the object, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic cross-section view illustrating a first embodiment of a structure of a selectable view angle (SVA) optical sensor according to the present invention.

FIG. 2 is a schematic cross-section view illustrating a second embodiment of a structure of a SVA optical sensor according to the present invention.

FIG. 3 is a schematic cross-section view illustrating a third embodiment of a structure of a SVA optical sensor according to the present invention.

FIG. 4 is a schematic cross-section view illustrating a forth embodiment of a structure of a SVA optical sensor according to the present invention.

FIG. 5 is a schematic top view illustrating the optical sensor configuration in a view angle response test.

FIGS. 6A and 6B are diagrams showing the results of the view angle response test for Non-SVA optical sensor and SVA optical sensor, respectively.

FIG. 7 is a schematic view illustrating an embodiment of an OPS apparatus using the SVA optical sensor to detecting a body in motion.

FIG. 8 is a schematic cross-section view illustrating a fifth embodiment of a structure of a SVA optical sensor according to the present invention.

### DETAILED DESCRIPTION OF THE PREFERRED EMBODIMENTS

Exemplary embodiments of the present invention are described herein in the context of a selectable view angle (SVA) optical sensor.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as throughout the drawings and the following detailed description to refer to the same or like parts.

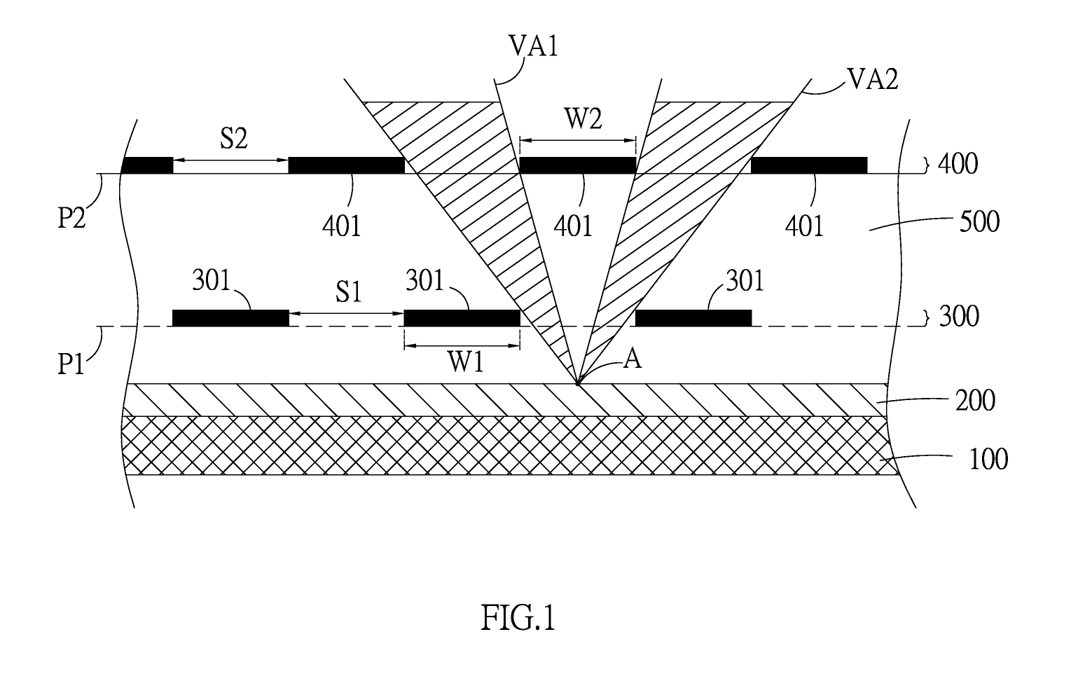

Please refer to FIG. 1 which is a schematic cross-section view illustrating a first embodiment of a structure of SVA optical sensor according to the present invention. As shown in the figure, the SVA optical sensor comprises a substrate 100, a photodiode array 200 disposed on the substrate 100, a first optical shielding modulation layer 300 disposed on a first plane P1 and a second optical shielding modulation layer 400 disposed on a second plane P2. The first plane P1 is on the photodiode array 200, the second plane P2 is on the first plane P1, and the first and second planes P1 and P2 and a top surface of the photodiode array 200 are substantially in parallel. The dimensions and configurations of the first and second optical shielding modulation layers 300 and 400 limit a field of view of the photodiode array 200 so that the photodiode array 200 has selectable view angle function.

Generally, SVA structures including the first and second optical shielding modulation layers 300 and 400 can block part of incoming light, thereby making the photodiode array 200 to receive light only from a predetermined area or at a predetermined angle. The predetermined area or the predetermined angle can be decided by the dimensions and configurations of the SVA structures, such as shape, size, or relative positions of the SVA structures. In addition, because of the layer structure of the first and second optical shielding modulation layers, the manufacturing process of the disclosed selectable view angle optical sensor can be fully compatible with complementary metal-oxide-semiconductor (CMOS) or BiCMOS process. Therefore, the SVA structures can be formed with the other structure of the SVA optical sensor concurrently without applying customized process for the SVA structure, so as to manufacture the SVA optical sensor without using special design equipment. It is worthy to mention that the photodiode array 200 may include one or more photodiodes and the type of the photodiodes can be determined by the type of the substrate. For example, in one embodiment, the substrate 100 is a P-type substrate, and the photodiode array 200 includes N+ photodiodes. In one embodiment, the substrate 100 may further comprise an epitaxial layer to improve the quality of the photodiode array 200. The photodiode array 200 may have a layer structure and be compatible with CMOS or BiCMOS process as well.

Please refer back to FIG. 1, the first optical shielding modulation layer 300 may comprise a plurality of first optical shielding strips 301 configured in parallel, the second shielding modulation layer 400 may comprise a plurality of second optical shielding strips 401 configured in parallel, and the plurality of first optical shielding strips 301 and the plurality of second optical shielding strips 401 may be substantially parallel to each other.

In this embodiment, the SVA structures including the first and second optical shielding modulation layers 300 and 400 can limit incoming light by the strip structures of the first and second optical shielding modulation layers 300 and 400. For example, please refer to point A of the photodiode array 200 in FIG. 1. The first and second optical shielding modulation layers 300 and 400 block part of the field of view of the point A and define two view angles VA1 and VA2 for the point A. That is, if the SVA structures can completely block (reflect and/or absorb) incoming light, the point A can only receive light coming in the range of the view angles VA1 and VA2 (diffracted light is neglected), and other light, such as light coming from right above, is blocked by the first and second optical shielding modulation layers 300 and 400. Since the light receiving area of the photodiode array 200 can be seen as a group of points like the point A, the SVA structures can define the field of view for the SVA optical sensor and make the SVA optical sensor have high directivity. This effect can be quantified as view angle response of an optical sensor in a cross-section view. For example, view angle 0 degree (normal to the first and second planes P1 and P2) may have weaker response for the SVA optical sensor in this embodiment. It is worthy to mention that the SVA optical sensor in the present invention is not limited to the strip structures of the first and second optical shielding modulation layers 300 and 400, other structures with the SVA function may be further incorporated in the present invention.

Please refer back to FIG. 1, the plurality of first optical shielding strips 301 may be spaced apart from each other at a first distance S1, and the plurality of second optical shielding strips 401 may be spaced apart from each other at a second distance S2.

To simplify the structures, the first distances S1 between the plurality of first optical shielding strips 301 may be the same, and the second distance S2 between the plurality of second optical shielding strips 401 may be the same. In this embodiment, the view angle response for the SVA optical sensor may be symmetric in a cross-section view, but the present invention is not limited thereto. In addition, a first width W1 of the first optical shielding strips 301 can be the same, and the second width W2 of the second optical shielding strips 401 can be the same. The plurality of first optical shielding strips 301 and the plurality of second optical shielding strips 401 can be disposed in an alternative way, so that the light coming from right above cannot reach the photodiode array 200 and the response at view angle 0 degree is weak for the SVA optical sensor.

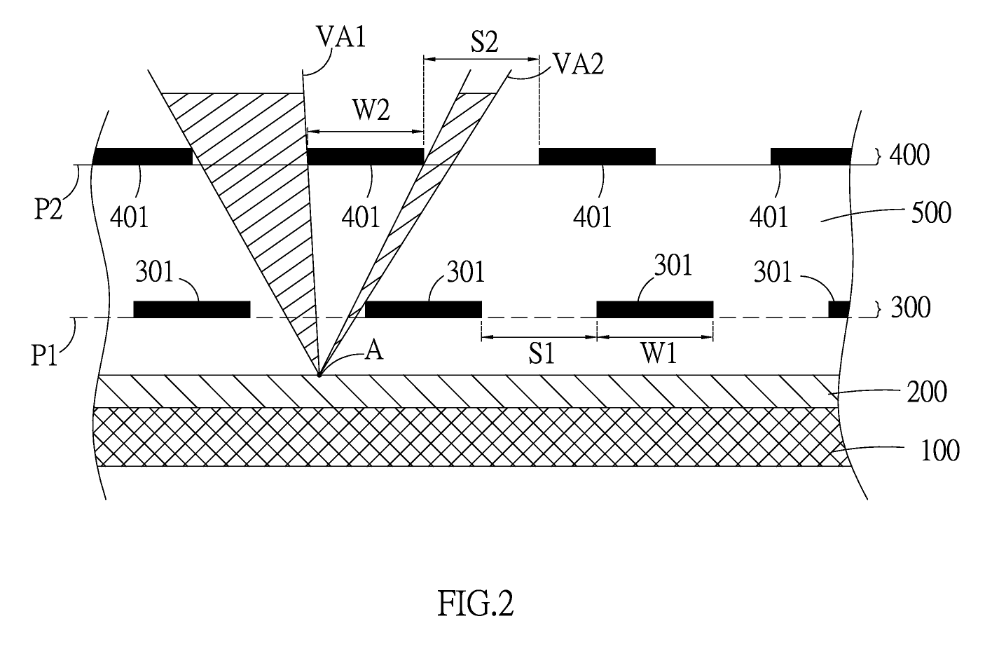

Please refer to FIG. 2 which is a schematic cross-section view illustrating a second embodiment of a structure of a SVA optical sensor according to the present invention. The structure of FIG. 2 is the same as that of FIG. 1, except for the relative positions between the first and second optical shielding modulation layers 300 and 400.

Generally, as mentioned before, the field of view of the photodiode array 200 can be defined by the relative positions of the SVA structures including the first and second optical shielding modulation layers 300 and 400. In FIG. 2, a first width W1 of the first optical shielding strips 301 and the second width W2 of the second optical shielding strips 401 can be the same. A right side of the second optical shielding strip 401 can be substantially aligned on a center of the first optical shielding strip 301, so that the point A in this embodiment has two different view angles VA1 and VA2 in FIG. 2, where the view angle VA1 is larger than the view angle VA2 here. Since the light receiving area of the photodiode array 200 of the SVA optical sensor can be seen as a group of points like point A, the SVA optical sensor may have asymmetric field of view between right and left sides in FIG. 2, so as to detect light coming from a predetermined angle. Such SVA optical sensor may be known as skewed selectable view angle (SSVA) optical sensor. In addition, since the patterns of the first and second optical shielding modulation layers 300 and 400 can be substantially the same, the first and second optical shielding modulation layers 300 and 400 can be formed by using the same mask in deposition process. Therefore, the field of view of the SVA optical sensor can be adjusted by changing the alignment between the formations of the first and second optical shielding modulation layers 300 and 400.

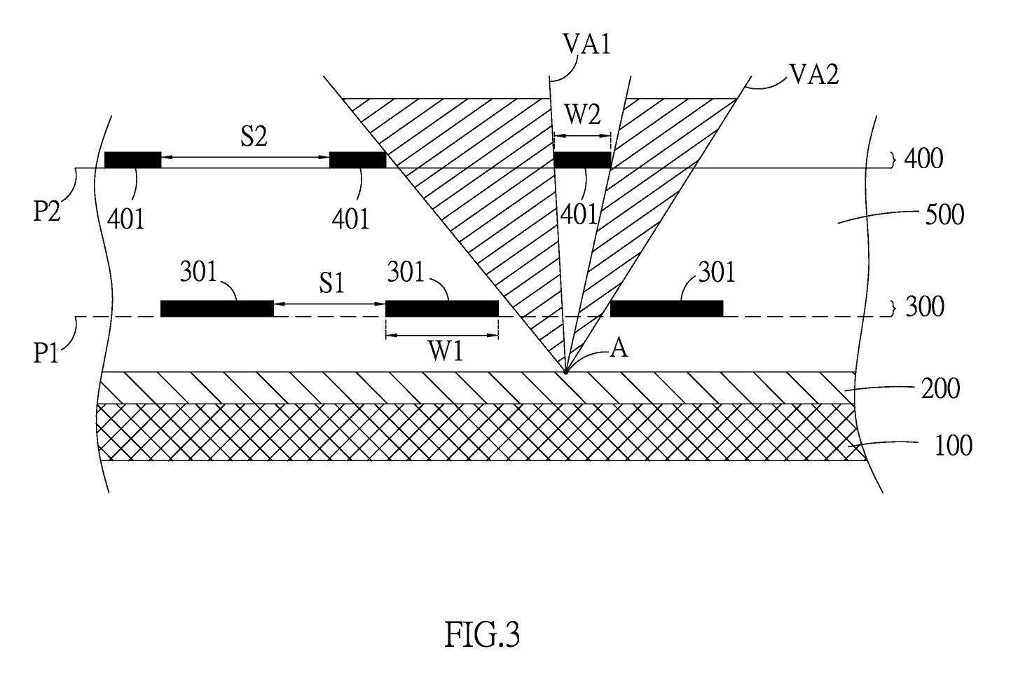

Please refer to FIG. 3 which is a schematic cross-section view illustrating a third embodiment of a structure of a SVA optical sensor according to the present invention. The structure of FIG. 3 is the same as that of FIG. 1, except that the second width W2 of the second optical shielding strips 401 becomes half and the second distance S2 changes accordingly.

In general, a SSVA optical sensor can be achieved by changing the dimensions of the first and second optical shielding modulation layers 300 and 400. Moreover, the field of view of the SVA optical sensor can be adjusted by changing the dimension of one of the first and second optical shielding modulation layers 300 and 400 only. In this embodiment, the field of view of the SVA optical sensor can be adjusted by changing the dimension of the second optical shielding modulation 400, and thus the SVA optical sensors with different field of view can be manufactured in the same process before the formation of the second optical shielding modulation 400.

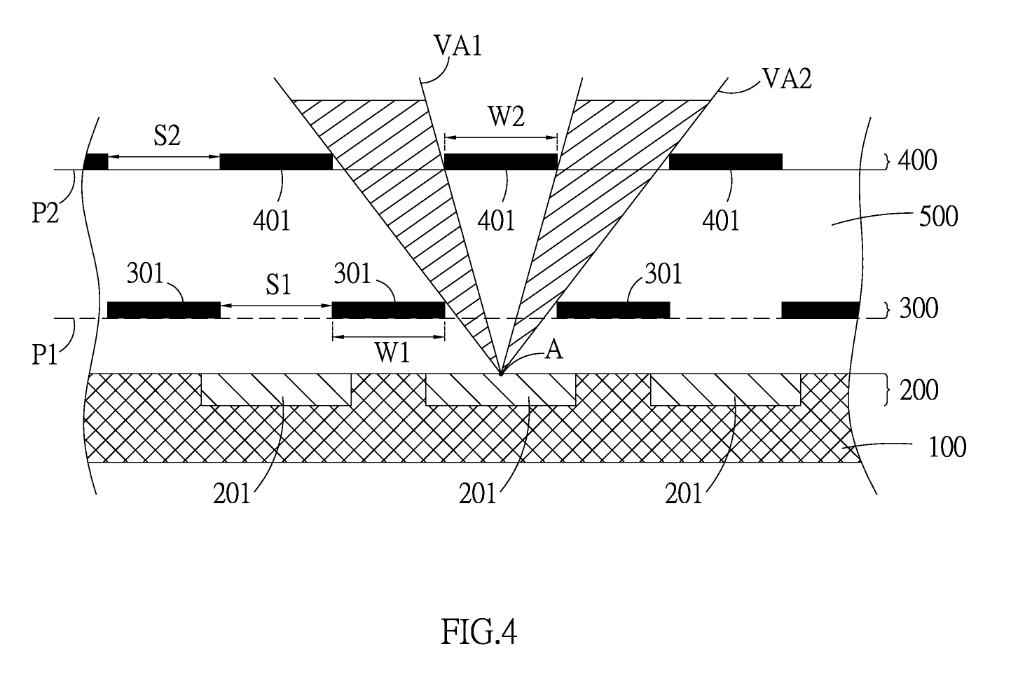

Please refer to FIG. 4 which is a schematic cross-section view illustrating a forth embodiment of a structure of a SVA optical sensor according to the present invention. The structure of FIG. 4 is the same as that of FIG. 1, except that the photodiode array 200 further comprises a plurality of sub-photodiodes 201.

In general, the photodiode array 200 may further comprises a plurality of sub-photodiodes 201, and each sub-photodiode 201 may receive light and send electric signal individually. Hence, the electric signals from the different sub-photodiodes can be used to detect and determine the target object in motion together, and the precision of determination may be increased. Although the SVA structures of this embodiment are similar to that of the first embodiment, in other embodiments, the SVA structures can be designed for each sub-photodiode 201 to increase the directivity. For example, the first and second distances S1 and S2 may become different between the first and second optical shielding strips 301 and 401 to make the field of view of each sub-photodiode concentrate on the same direction.

Preferably, the first or second optical shielding modulation layers 300 and 400 may be made of metal.

In general, one of the materials used to block light is metal. Therefore, the first or second optical shielding modulation layers 300 and 400 may be made of metal such as Al or Cu, and may be readily formed by metal deposition process with common metal deposition equipment.

Preferably, the first or second optical shielding modulation layers 300 and 400 may be interference filters.

The first or second optical shielding modulation layers 300 and 400 may be interference filters, for example, Fabry-Perot interference filters. Since the transmission spectrum of Fabry-Perot interference filter can exhibit high transmission if the incoming light satisfies the resonance condition, the first or second optical shielding modulation layers 300 and 400 may use Fabry-Perot interference filter structure to increase the selectability for the wavelength of light. In other words, the optical method to detect an object in motion is to emit light onto the object and then receive and analyze the light reflected by the body, and the light is emitted from a predetermined light source like a light emitting diode (LED) or a vertical-cavity surface-emitting laser (VCSEL) and the wavelength of the light is predetermined as well. Hence, if the first or second optical shielding modulation layers 300 and 400 have high transmission for the light from the predetermined light source and low transmission for other ambient light, the interference of the desired optical signal due to noise such as background stray light can be effectively blocked, and the sensing signal to noise ratio can be increased. The structure of interference filter can be formed by deposition process, for example, physical vapor deposition (PVD).

Preferably, the selectable view angle optical sensor may further comprise a dielectric layer 500 disposed between the first and the second optical shielding modulation layers 300 and 400.

Please refer back to one of FIGS. 1 to 4, the selectable view angle optical sensor may further comprise a dielectric layer 500 disposed between the first and second optical shielding modulation layers 300 and 400. The dielectric layer 500 may be formed on the photodiode array 200 by deposition process. The dielectric layer 500 may separate the first and second optical shielding modulation layers 300 and 400 at a predetermined distance, for example, 5 um. The dielectric layer 500 may be transparent for light with a predetermined wavelength.

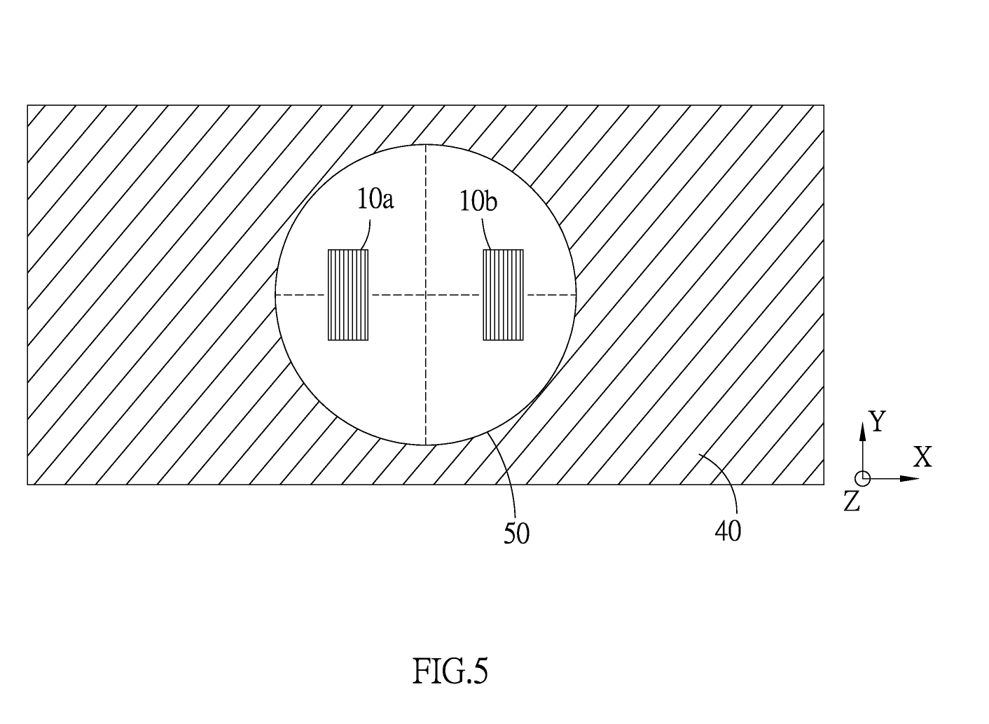

Please refer to FIG. 5 which is a schematic top view illustrating the optical sensor configuration in a view angle response test. In FIG. 5, the optical sensor configuration in the view angle response test include two optical sensors 10a and 10b and cover lens 40 including a cover lens window 50.

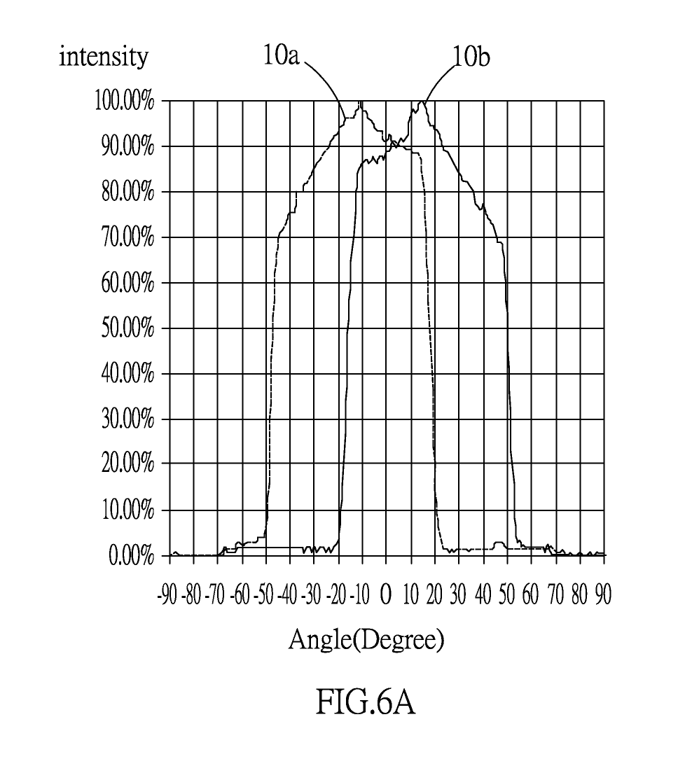

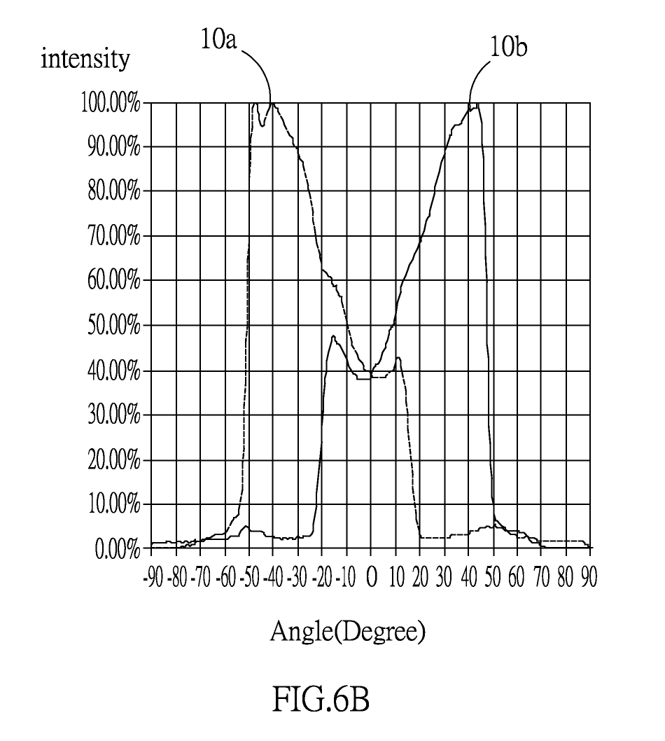

As mentioned before, the field of view of a photodiode array can be quantified as the view angle response. In this view angle test, light incoming from different angle is emitted onto the optical sensors 10a and 10b through the cover lens window 50 of the cover lens 40. The angle at which the light comes from is defined in X-Z plane in FIG. 5, where the light from angle 0 degree means the light coming in a direction normal to the top surface (X-Y plane) of the optical sensors 10a and 10b. The test results for the optical sensors 10a and 10b with and without the SVA structure are shown in FIGS. 6A and 6B, respectively.

Please refer to FIGS. 6A and 6B which are diagrams showing the results of the view angle response test mentioned above for Non-SVA optical sensors and SVA optical sensors, respectively. Here, Non-SVA optical sensors are the optical sensors without the SVA structure.

FIG. 6A is the test result for the optical sensors 10a and 10b without the SVA structures. In FIG. 6A, the left curve is from the optical sensor 10a without the SVA structures, and the right curve is from the optical sensor 10b without the SVA structures. It can be seen the peak value of the view angle response for the two optical sensors 10a and 10b without the SVA structures are at angle±10 degree, respectively. Besides, the view angle where the two optical sensors 10a and 10b have high view angle response intensity (>80%) overlap each other in a range of −15 degree to +15 degree, and the peak value of the view angle response for the two optical sensors 10a and 10b without the SVA structures are within the overlapping range.

In contrast, FIG. 6B is the test result for the optical sensors 10a and 10b with the SVA structures. In FIG. 6B, the left curve is from the optical sensor 10a with the SVA structures, and the right curve is from the optical sensor 10b with the SVA structures. It can be seen the peak value of the view angle response for the two optical sensors 10a and 10b without the SVA structures are at angle±40 degree, respectively. Besides, the view angles where the two optical sensors 10a and 10b have high view angle response intensity (>80%) do not overlap each other.

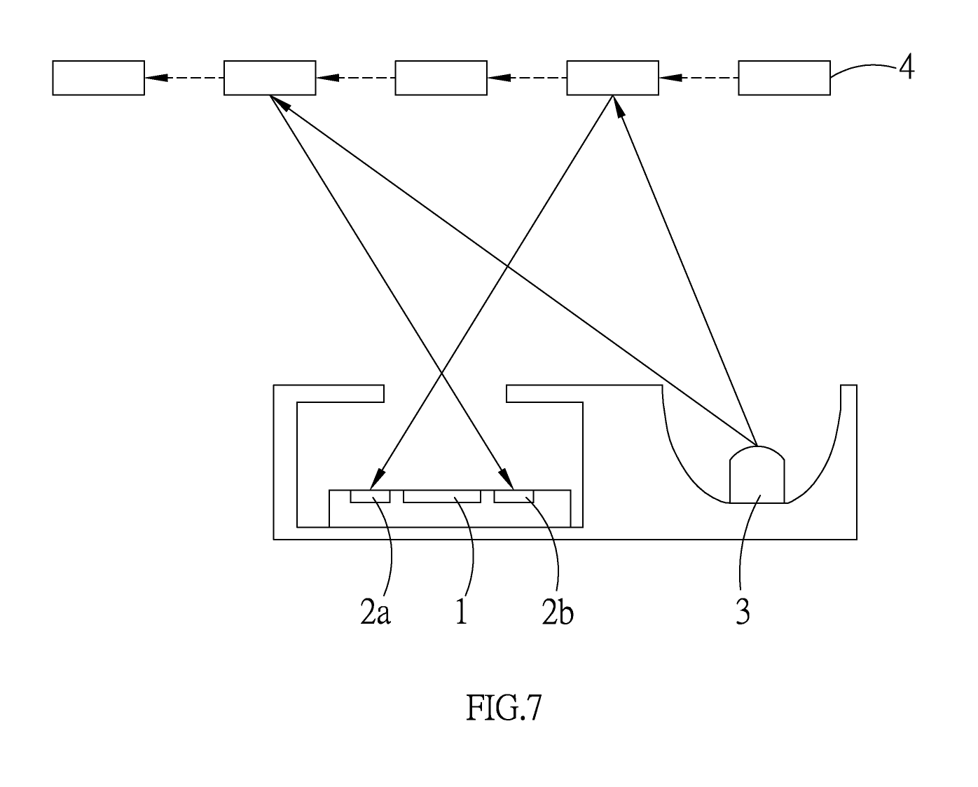

Please refer to FIG. 7 which is a schematic view illustrating an embodiment of an OPS apparatus using the SVA optical sensor to detecting a body in motion 4. The OPS apparatus comprises a center optical sensor 1, two side optical sensors 2a and 2b, and a light source 3. The center optical sensor 1 is an array of light sensors used to receive light with different wavelength including ultraviolet (UV), visible (RGB), and infrared (IR) wavelengths. The light source 3 emits light onto the body in motion 4, and the light reflected by the body in motion 4 is received by the two optical sensors 2a and 2b so that the OPS apparatus can determine the direction of the body in motion 4.

In one embodiment, the light source 3 continuously emits light, and the OPS apparatus determine the direction of the body in motion 4 by the time difference between when the two side optical sensor 2a and 2b have max intensity of the received light. If the two side optical sensor 2a and 2b do not have the SVA structures, the time difference may be too small to be used to determine the time order, and therefore it is difficult for the OPS to determine the direction of the body in motion 4. Besides, since the ranges of the view angle where the two side optical sensors 2a and 2b have high view angle response intensity may overlap each other as shown in FIG. 6B, the OPS apparatus may not clearly distinguish the intensity of the signals from the two side optical sensor 2a and 2b without the SVA structures when light comes from the angle overlapping range. In contrast, if the two side optical sensor 2a and 2b have the SVA structures, the time difference is large and can be easily handled to determine the time order. In addition, since the ranges of the view angle where the two side optical sensors 2a and 2b have high view angle response intensity do not overlap each other as shown in FIG. 6B, the OPS apparatus can easily distinguish the signals when the two side optical sensor 2a and 2b have large responses from the received light. In other words, the SVA optical sensors can provide signals in a much wider view angle than the non-SVA sensor. Therefore, the processing unit of the OPS apparatus is able to determine the direction of the body in motion 4.

It is worthy to mention that although the side optical sensors 2a and 2b in FIG. 7 disposed for detecting the body in motion 4 in one direction, the OPS apparatus may include a plurality of the side optical sensors disposed around the center optical sensor 1, thereby detecting the body in motion 4 in different directions.

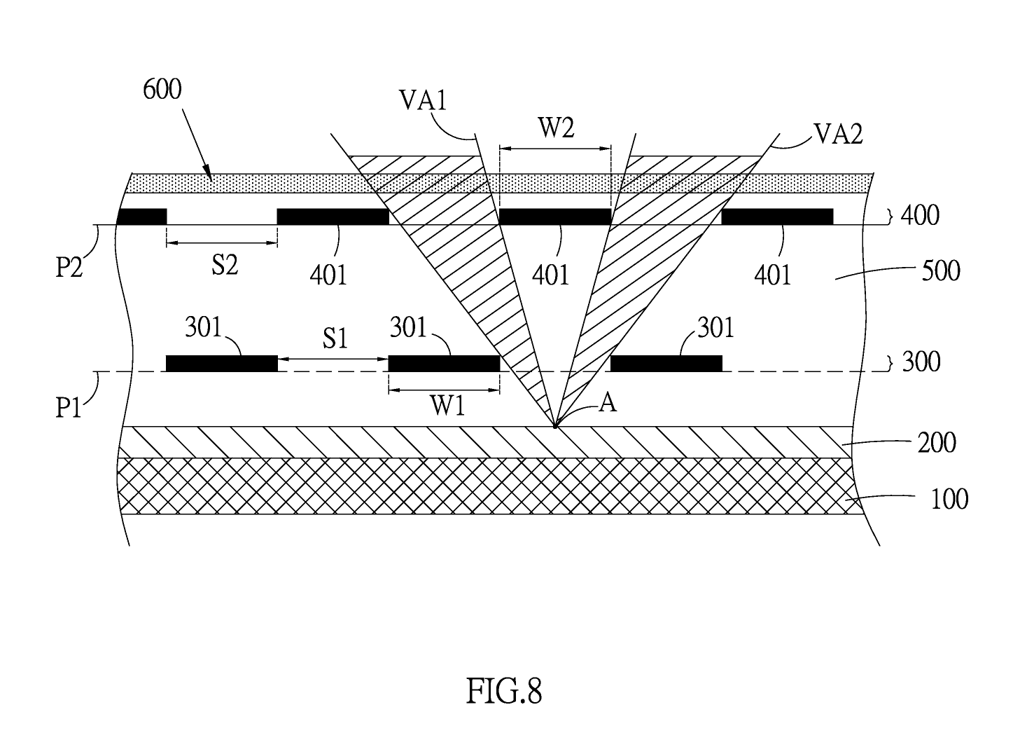

Please refer to FIG. 8 which is a schematic cross-section view illustrating a fifth embodiment of a structure of SVA optical sensor according to the present invention. The structure of the SAV optical sensor is in fact similar to that in FIG. 1, except for an optical filter layer 600 disposed on the second optical shielding modulation layer 400. The description for the similar structure is omitted to avoid obscuring the subject.

In general, the SVA optical sensor can offer better selectivity on wavelength of a light source by the optical filter layer 600. That is, the optical filter layer 600 can only have narrow band in light transmission and hence only allow light with a predetermined wavelength to pass. As a result, the SVA optical can more effectively block undesired ambient light with other wavelength. In other words, in this case, the spatial selectivity can be mainly offered by the first and second optical shielding modulation layers 300 and 400 and the wavelength selectivity can be mainly offered by the optical filter layer 600. Therefore, the signal to noise performance for gesture and motion sensing can be further improved. The optical filter layer 600 substantially has a layer structure, so it can be easily compatible with the manufacturing process for the other components of the SVA optical sensor depending on used material and fine structures of the optical filter layer 600.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A selectable view angle optical sensor, comprising:
a substrate;
a photodiode array disposed on the substrate;
a first optical shielding modulation layer disposed on a first plane, the first plane on the photodiode array; and
a second optical shielding modulation layer disposed on a second plane, the second plane on the first plane,
wherein the first and second planes and a top surface of the photodiode array are substantially in parallel, and dimensions and configurations of the first and second optical shielding modulation layers limit a field of view of the photodiode array.

2. The selectable view angle optical sensor as claimed in claim 1, wherein the first optical shielding modulation layer comprises a plurality of first optical shielding strips configured in parallel, the second shielding modulation layer comprises a plurality of second optical shielding strips configured in parallel, and the plurality of first optical shielding strips and the plurality of second optical shielding strips are substantially parallel to each other.

3. The selectable view angle optical sensor as claimed in claim 2, wherein the plurality of first optical shielding strips are spaced apart from each other at a first distance, and the plurality of second optical shielding strips are spaced apart from each other at a second distance.

4. The selectable view angle optical sensor as claimed in claim 3, wherein the photodiode array has two different viewing angles of the field of view in a cross-section view.

5. The selectable view angle optical sensor as claimed in claim 1, wherein the photodiode array further comprises a plurality of sub-photodiodes.

6. The selectable view angle optical sensor as claimed in claim 1, wherein the first or second optical shielding modulation layers are made of metal.

7. The selectable view angle optical sensor in claim 1, wherein the first or second optical shielding modulation layers are interference filters.

8. The selectable view angle optical sensor in claim 1, further comprises:
a dielectric layer disposed between the first and the second optical shielding modulation layers.

9. A selectable view angle optical sensor, comprising:
a substrate;
a photodiode array disposed on the substrate;
a first optical shielding modulation layer disposed on a first plane, the first plane on the photodiode array;
a second optical shielding modulation layer disposed on a second plane, the second plane on the first plane; and
an optical filter layer disposed on the second optical shielding modulation layer to allow light with a predetermined wavelength passing through the selectable view angle optical sensor,
wherein the first and second planes and a top surface of the photodiode array are substantially in parallel, and dimensions and configurations of the first and second optical shielding modulation layers limit a field of view of the photodiode array.

10. The selectable view angle optical sensor as claimed in claim 9, wherein the first optical shielding modulation layer comprises a plurality of first optical shielding strips configured in parallel, the second shielding modulation layer comprises a plurality of second optical shielding strips configured in parallel, and the plurality of first optical shielding strips and the plurality of second optical shielding strips are substantially parallel to each other.

11. The selectable view angle optical sensor as claimed in claim 10, wherein the plurality of first optical shielding strips are spaced apart from each other at a first distance, and the plurality of second optical shielding strips are spaced apart from each other at a second distance.

12. The selectable view angle optical sensor as claimed in claim 11, wherein the photodiode array has two different viewing angles of the field of view in a cross-section view.

13. The selectable view angle optical sensor as claimed in claim 9, wherein the photodiode array further comprises a plurality of sub-photodiodes.

14. The selectable view angle optical sensor as claimed in claim 9, wherein the first or second optical shielding modulation layers are made of metal.

15. The selectable view angle optical sensor in claim 9, further comprises:
a dielectric layer disposed between the first and the second optical shielding modulation layers.
